(19) United States
(12) Patent Application Publication
(10) Pub. No.: US 2006/0018455 A1
(43) Pub. Date: Jan. 26, 2006

(54) Collecting data from telephone users by mid-call event signaling

(75) Inventors: Ofer Refael Salomon, Kfar Hanagid (IL); Eran Dotan, Tel Aviv (IL); Boaz Goldman, Moshav Shoeva (IL); Raanan Nochian, Tel Aviv (IL)

Correspondence Address: Julian H. Cohen;Ladas & Parry, 26 West 61 Street, New York, NY, 10023, US

(73) Assignee: SMART-SS7 LTD.

(21) Appl. No.: 10/898,681

(22) Filed: Jul. 23, 2004

(51) Int. Cl. H04M 7/00; H04N 7/173

(52) U.S. Cl. 379/229; 725/99

(57) ABSTRACT

A method for collecting information from a user of a telephone includes receiving a request at a switch in a telephone network to open a voice call from the telephone to a specified telephone number. Responsively to the request, a voice call is initiated by opening a first leg of a connection from the switch to the telephone, and a second leg of the connection from the switch to a peripheral device. The second leg is disconnected after initiating the voice call, while leaving the first leg of the connection open. After disconnecting the second leg, signals are received over the first leg of the connection responsively to one or more keystrokes made by the user on the keypad of the telephone.

### FIELD OF THE INVENTION

The present invention relates generally to communication systems and methods, and specifically to efficient methods for collecting data via a telephone network.

### BACKGROUND OF THE INVENTION

Interactive voice response (IVR) is a well-known model for automated communication with telephone users over a telephone network. Typically, when a user dials in to a certain number that is configured for IVR, the telephone network switch opens a voice call between the user and the IVR device. The IVR device answers the call and then enunciates one or more voice prompts, to which the user responds by pressing appropriate keys on the telephone keypad. The IVR device receives the keystrokes, typically in the form of Dual-Tone Multi-Frequency (DTMF) audio signals conveyed over the telephone network, and thus records and responds to the user inputs.

Although IVR is an effective model for handling individual calls, each call to the IVR still consumes substantial machine and network resources. For each call in progress, the IVR itself must set aside sufficient computing and audio resources to handle the call for as long as the call is connected. The telephone network must also allocate communication resources to keep both legs of the call open (to the telephone and to the IVR device) at the switch or switches handling the call. As a result, in large-scale applications involving interactive response by multiple users via telephone, IVR may be impractical and excessively costly. Therefore, operators of these applications sometimes use other, less convenient alternatives for receiving inputs from telephone users, such as text-based short message service (SMS).

### SUMMARY OF THE INVENTION

Embodiments of the present invention provide improved methods and systems for collecting keypad inputs from telephone users. These methods and system enable users to provide inputs to an application via a telephone network with the convenience and simplicity of voice calling, but without requiring that an IVR device be connected continuously to the call.

In some embodiments of the present invention, a novel call handling technique is initiated when a user places a call to a telephone number that is associated with an application requiring keypad inputs from the user. The telephone network switch that receives the call notifies a service control point (SCP) that is associated with the application (and hence with the telephone number that the user has called). Under instructions from the SCP, the switch opens the first leg of a connection from the switch to the telephone, and a second leg of the connection from the switch to a network peripheral, such as an audio response device. The audio response device makes an initial response to the call, thus establishing the connection with the telephone in accordance with telephone signaling conventions.

Once the connection has been established in this manner, the SCP instructs the switch to disconnect the second leg of the connection, while leaving the first leg open. The resources of the audio response device are now freed to initiate another call, and the portion of the telephone network resources associated with the second leg of the connection is freed, as well. From the point of view of the telephone user, however, the call is still connected. The resulting one-legged call is a novel use of the standard facilities of SS-7 telephone networks, which is made possible by the unique capabilities of the SCP.

Subsequently, the user may key in numeric entries via the keypad of the telephone, typically in response to some prompt unconnected with the telephone. For example, the user may be prompted by a television program that he or she is watching to press keys in order to make choices in an on-line poll. The switch receives signals in response to the user keystrokes and informs the SCP of the signals it has received. For example, the switch may convey to the SCP mid-call events corresponding to the keystrokes, as specified by Capabilities Set 1 (CS-1) or Capabilities Set 2 (CS-2) of the Intelligent Network Application Protocol (INAP) standards. The SCP processes these events, typically by reporting them to a server running the application in question. The user may press multiple keys in succession, for as long as the first leg of the call remains connected between the telephone and the switch, thus providing multiple inputs to the application.

There is therefore provided, in accordance with an embodiment of the present invention, a method for collecting information from a user of a telephone having a keypad, the method including:
receiving a request at a switch in a telephone network to open a voice call from the telephone to a specified telephone number;
responsively to the request, initiating a voice call by opening a first leg of a connection from the switch to the telephone, and a second leg of the connection from the switch to a peripheral device;
disconnecting the second leg after initiating the voice call, while leaving the first leg of the connection open; and
after disconnecting the second leg, receiving signals over the first leg of the connection responsively to one or more keystrokes made by the user on the keypad of the telephone.

Typically, the peripheral device includes an audio response device, and initiating the voice call includes receiving an audio reply from the audio response device in response to opening the second leg of the connection. In a disclosed embodiment, the telephone network includes a circuit-switched telephone network, operating in accordance with a Signaling System 7 (SS7) protocol.

In an aspect of the invention, receiving the signals includes reporting the keystrokes to a service control point (SCP). In a disclosed embodiment, reporting the keystrokes to the SCP includes generating mid-call events at the switch in response to the keystrokes, and conveying the mid-call events over the telephone network to the SCP. Additionally or alternatively, receiving the request includes, responsively to the specified telephone number, reporting the request to the SCP, and initiating the voice call and disconnecting the second leg include controlling functions of the switch responsively to instructions from the SCP.

There is also provided, in accordance with an embodiment of the present invention, a method for collecting information from a user of a telephone having a keypad, the method including:
presenting the user with a prompt on a medium unconnected with the telephone, the prompt soliciting a reply from the user by means of a telephone call to a specified telephone number;
receiving a request at a switch in the telephone network to open a voice call from the telephone to the specified telephone number;
responsively to the request, opening a connection with the telephone over the telephone network; and
receiving signals over the connection responsively to one or more keystrokes made by the user on the keypad of the telephone, indicating the reply to the prompt presented on the medium.

In an aspect of the invention, opening the connection includes opening a second leg of the connection from the switch to a peripheral device, and disconnecting the second leg after initiating the voice call, while leaving the first leg of the connection open for receiving the signals responsively to the one or more keystrokes. Typically, the peripheral device includes an audio response device, and initiating the voice call includes receiving an audio reply from the audio response device in response to opening the second leg of the connection.

In some embodiments, receiving the signals includes reporting the keystrokes to a service control point (SCP). In one embodiment, the method includes conveying data from the SCP to a server indicative of the keystrokes made by the user, and tabulating the data at the server. Tabulating the data may include computing an output value based on the data, and including displaying the output value on the medium.

In a disclosed embodiment, receiving the request includes receiving multiple, respective requests from multiple users to open simultaneous voice calls to the specified telephone number, and opening the connection includes opening multiple simultaneous connections responsively to the requests, and receiving the signals includes receiving keystroke inputs from the multiple users over the simultaneous connections, and computing the output value includes tabulating selections made by the multiple users in response to the prompt, as indicated by the keystroke inputs. In this embodiment, the medium includes a television medium, and presenting the user with the prompt includes providing the prompt in a television program, and displaying the output value includes presenting the output value on the television program following the prompt.

There is additionally provided, in accordance with an embodiment of the present invention, apparatus for collecting information from a user of a telephone having a keypad, the apparatus including a service control point (SCP), which is adapted to receive a first message from a switch in a telephone network, indicative of a request received by the switch to open a voice call from the telephone to a specified telephone number, and responsively to the first message, to initiate a voice call by causing the switch to open a first leg of a connection from the switch to the telephone and to open a second leg of the connection from the switch to a peripheral device,
wherein the SCP is further adapted to instruct the switch to disconnect the second leg after initiating the voice call, while leaving the first leg of the connection open, and to receive a second message from the switch indicative of signals received at the switch over the first leg of the connection responsively to one or more keystrokes made by the user on the keypad of the telephone after disconnecting the second leg of the connection.

There is further provided, in accordance with an embodiment of the present invention, apparatus for collecting information from a user of a telephone having a keypad, the apparatus including:
a medium unconnected with the telephone, which is controlled so as to present the user with a prompt soliciting a reply from the user by means of a telephone call to a specified telephone number;
a switch in the telephone network, which is adapted to receive a request to open a voice call from the telephone to the specified telephone number and to issue a first message over the telephone network responsively to the request; and
a service control point (SCP), which is coupled to the telephone network so as to receive the first message, and which is adapted, responsively to the first message, to cause the switch to open a connection with the telephone over the telephone network, so as to receive signals over the connection responsively to one or more keystrokes made by the user on the keypad of the telephone, indicating the reply to the prompt presented on the medium.

The present invention will be more fully understood from the following detailed description of the embodiments thereof, taken together with the drawings in which:

### BRIEF DESCRIPTION OF THE DRAWINGS

FIG. 1 is a schematic, pictorial illustration of a system for receiving user inputs via a telephone in response to prompts presented on a medium unconnected to the telephone, in accordance with an embodiment of the present invention;

FIG. 2 is a block diagram that schematically illustrates elements of an intelligent network system, in accordance with an embodiment of the present invention; and

FIG. 3 is a message diagram showing communications involved in conveying user inputs, made via keystrokes on a telephone, to an application server, in accordance with an embodiment of the present invention.

### DETAILED DESCRIPTION OF EMBODIMENTS

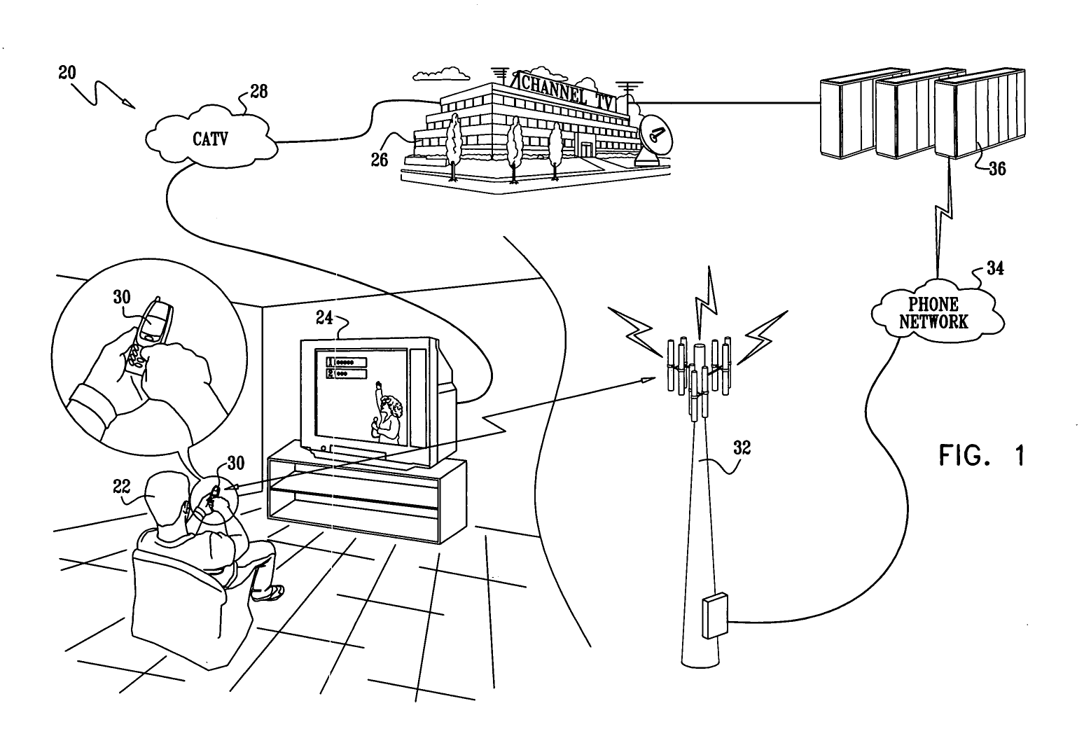

FIG. 1 is a schematic, pictorial illustration of a system 20 for receiving inputs from a user 22 via a telephone 30, in accordance with an embodiment of the present invention. The inputs are received in response to prompts presented on a medium unconnected to the telephone, in this case on a television 24. In this exemplary embodiment, a television station 26 broadcasts a program via a broadcast medium 28, such as a television cable network. In the course of the program, the announcer presents user 22 (along with thousands of other viewers) with a number of choices, for example, names of candidates in an election or participants in a television talent contest. The announcer prompts the user to call in to a certain telephone number and, during the call, to press numbers on the keypad of telephone 30 corresponding to a selection from among the available choices.

Signals from telephone 30 are conveyed via a base station 32 to a circuit-switched telephone network 34. Although in this example, telephone 30 is shown to be a cellular telephone, the principles of the present invention are equally applicable to wireline telephones and networks. User 22 first dials the telephone number indicated by the announcer on the television program, and a voice call is accordingly opened between telephone 30 and network 34. The voice call is established and maintained in a novel manner that minimizes the use of network-side resources in handling the call, as described in detail with reference to the figures that follow.

Once the call is established, each keystroke by the user on the telephone keypad causes an event to be generated in network 34 and conveyed to a server 36. The server records the events, i.e., it records the keystroke choices made by user 22 and by other users who call in to the specified number. Multiple keystrokes may be input and recorded in this manner by each user, and by many different users simultaneously, for as long as the user voice calls remain connected. In this manner, for example, the television program may present a sequence of questions, and the users may respond to each one. The user voice call may remain open in this manner for an extended period of time, during which it is necessary for the user to press only a single key or sequence of keys to provide each successive input to server 36. This user-friendly model contrasts with methods known in the art for response using utilities such as SMS, wherein the user must send each successive response as a separate SMS message. Server 36 is thus able to collect many inputs from many users simultaneously. Typically, in the exemplary embodiment shown in the figure, the results are tabulated in real time and are then shown on the television program immediately after each question or a group of questions is presented to the viewers.

Although in the example shown in FIG. 1, user 22 receives the prompt to place a call and enter responses from the television medium, in other embodiments the prompt may be presented on media of other types. For example, the user may receive prompts from a radio program, from a printed notice, from a display screen in a public place (such as a mall, airport or train terminal), or from a point-of-sale or information kiosk. All such alternative media are considered to be within the scope of the present invention, when used in conjunction with the novel system configuration and communication methods described below.

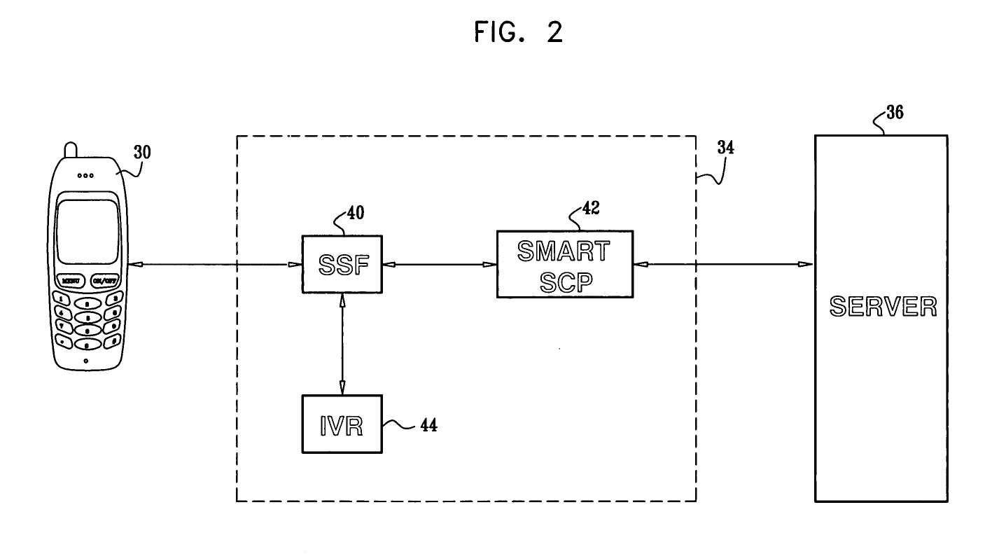

FIG. 2 is a block diagram that schematically illustrates elements of network 34 that are used in collecting telephone keypad inputs, in accordance with an embodiment of the present invention. For the purposes of this embodiment, the elements of network 34 that are shown in the figure are assumed to communicate in accordance with the widespread Signaling System 7 (SS7) set of protocols and to have Intelligent Network (IN) capabilities, as specified by the above-mentioned INAP. For the sake of simplicity and clarity, FIG. 2 shows only those elements of network 34 that are necessary for a conceptual understanding of the present invention.

When the user of telephone 30 places a call to a given telephone number, a corresponding call request signal is received by a switch 40 in network 34. In accordance with the IN model, switch 40 is programmed with a call control function (CCF) and a service switching function (SSF). When the CCF detects signaling passing through the switch that is directed to a telephone number belonging to an IN service, it suspends the call temporarily and passes a trigger to the SSF. Based on the trigger, the SSF of switch 40 passes control of the call to a smart service control point (SCP) 42. The SCP typically comprises hardware interfaces for communicating with switch 40 and server 36, and a processor that is programmed in software to carry out the functions described hereinbelow. SCP 42 processes the call, and then sends instructions back via INAP to switch 40 as to how the call should be handled by the CCF. Although SCP 42 has novel capabilities that are required for carrying out this embodiment of the present invention, switch 40 and other elements of network 34 may be standard, off-shelf components, operating in accordance with the SS7 and INAP standards without modification.

In the example illustrated in FIG. 1, when user 22 dials the number that is announced on the television program he is watching, switch 40 suspends and refers the call to SCP 42, which analyzes the call and then returns instructions to the switch. These instructions initially instruct the switch to transfer the call to an IVR device 44, which is configured in accordance with INAP as an intelligent peripheral (IP). Thus, the call now has two legs, as required by SS-7 conventions: a first leg between telephone 30 and switch 40, and a second leg between the switch and IVR device 44. (Although for simplicity, both legs are shown as being connected to the same switch 40, in practice the first and second legs may be connected to different switches, which communicate with one another via network trunk lines, as is known in the art.) In order to establish the second leg and thus complete the connection of the call, the IVR device plays a prerecorded or synthesized audio response, typically a brief announcement, such as “Welcome to the TV automatic response system,” or even a simple “beep” or other tone.

Switch 40 notifies SCP 42 that the call has been connected. In response, the SCP immediately instructs the switch to disconnect the second leg of the call, between the switch and IVR device 44. Subsequently, only one half of the call remains connected, i.e., the first leg between telephone 30 and switch 40. In conventional network implementations, this remaining leg would immediately be disconnected, as well. In the present embodiment, however, the “half call” between telephone 30 and switch 40 remains open. From the point of view of user 22, telephone 30 is still connected by an ordinary voice call to the number that he has dialed.

While the half call remains open, user 22 presses keys on the telephone keypad in order to indicate his selections or other inputs in response to prompts provided on television 24. Each keystroke generates a corresponding signal to switch 40. In response to each such signal, the SSF of switch 40 generates a mid-call event, which it conveys to SCP 42 in the manner specified by INAP. Each of these mid-call events indicates to SCP 42 the key that user 22 has pressed.

SCP 42 notifies server 36 of each call that is established and each keystroke event that it receives in the context of this half-call keypad entry service. (SCP 42 may be configured to perform other IN services, as well, but only the keypad entry service is relevant to the present embodiment.) SCP 42 may communicate with server 36 using any suitable data communications protocol known in the art. For example, the SCP and server may be connected to communicate via a packet network (not shown) by means of TCP/IP packets. Server 36 is programmed to tabulate the keystroke data and to perform appropriate actions with respect to the data, such as reporting the data to television station 26 in the example of FIG. 1. Alternatively or additionally, the server may be programmed to take other actions, such as charging a billing account of user 22, or delivering content or other goods or services to the user.

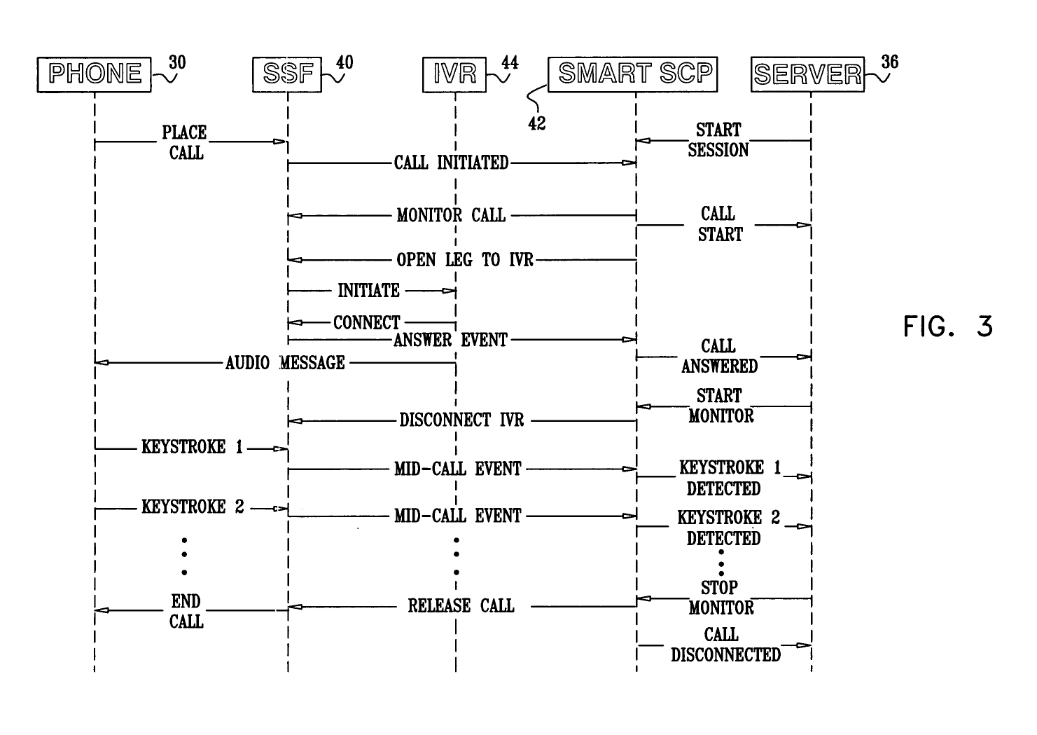

FIG. 3 is a message diagram showing communications between the elements of FIG. 2, in accordance with an embodiment of the present invention. Data collection by telephone keypad entry is initiated by server 36, which instructs SCP 42 to begin a data collection session. When user 22 places a call via telephone 30 to the telephone number specified for keypad entry service, switch 40 notifies SCP 42 that a call has been initiated. In accordance with INAP convention, the switch may give this notification by sending an IDP (Initial Detected Point) message to the SCP. In response to this message, as long as the data collection session is in process, SCP 42 informs switch 40 that the SCP wishes to monitor the call. In INAP terms, for this purpose, the SCP sends RRB (Request Report Basic call state module [BCSM]) messages to the switch regarding both leg 1 (telephone-switch) and leg 2 (switch-IVR) of the call. The RRB message regarding leg 1 instructs switch 40 to report mid-call events to SCP 42 in response to keystrokes entered on telephone 30 during the call, up to a maximum number of events specified by the message.

To complete the call, SCP 42 instructs switch 40 to open the second leg of the call to IVR device 44. INAP provides a number of different message types that can be used for this purpose. For example, the SCP may send the switch an ETC (Establish Temporary Connection) or ICA (Initiate Call Attempt) message. In response to this message, switch 40 initiates a connection with the IVR device. Typically, the switch uses conventional ISUP (ISDN User Part) signaling for this purpose, such as an IAM (Initial Address Message) signal, which reserves a circuit to carry the call. The IVR device responds by accepting the call and playing an audio message or other signal, as described above. The second leg of the call is thus connected.

Upon connection of the call, switch 40 sends an event message to SCP 42 to indicate that the call has been answered. SCP 42 notifies server 36 that a new call has been opened, and the server instructs the SCP to begin monitoring keystrokes made on telephone 30. The SCP immediately instructs switch 40 to disconnect the second leg of the call, between the switch and IVR device 44. The form of the message that is used for this purpose depends on the type of message that the SCP sent to open the call. For example, if the SCP sent an ETC message to open the call, it may now send a DFC (Disconnect Forward Communication) message with respect to leg 2. Alternatively, if the SCP previously sent an ICA message, it may now send a RCP (Release Call Party) message. In response to the message from the SCP, switch 40 disconnects the IVR device from the call and releases the telephone network circuit that was reserved for the second leg. Upon disconnection of the second leg of the call, IVR device 44 also releases the resources that it allocated for handling the call, and these resources are now available to take a call from another telephone user.

After disconnection of the IVR device, user 22 enters keystrokes using the keypad of telephone 30. In response to each keystroke (up to the maximum specified by the previous RRB message), switch 40 reports a mid-call event to SCP 42. The SCP then reports each keystroke detected to server 36. This reporting procedure continues for the duration of the call, or until the server instructs the SCP to stop monitoring the call (as shown in FIG. 3). In this latter case, SCP 42 instructs switch 40 to release the remaining leg of the call, and the switch accordingly disconnects telephone 30 and thus ends the call. SCP 42 informs server 36 that the call has been disconnected. The SCP may continue to receive and report on data inputs from other users for as long as server 36 keeps the session open.

Although the embodiments described above make use of the features of certain communication protocols and signaling provided by these protocols, the principles of the present invention may similarly be applied over telephone networks of other types, using other suitable protocols and message types. It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for collecting information from a user of a telephone having a keypad, the method comprising:
receiving a request at a switch in a telephone network to open a voice call from the telephone to a specified telephone number;
responsively to the request, initiating a voice call by opening a first leg of a connection from the switch to the telephone, and a second leg of the connection from the switch to a peripheral device;
disconnecting the second leg after initiating the voice call, while leaving the first leg of the connection open; and
after disconnecting the second leg, receiving signals over the first leg of the connection responsively to one or more keystrokes made by the user on the keypad of the telephone.

2. The method according to claim 1, wherein the peripheral device comprises an audio response device, and wherein initiating the voice call comprises receiving an audio reply from the audio response device in response to opening the second leg of the connection.

3. The method according to claim 1, wherein the telephone network comprises a circuit-switched telephone network, operating in accordance with a Signaling System 7 (SS7) protocol.

4. The method according to claim 1, wherein receiving the signals comprises reporting the keystrokes to a service control point (SCP).

5. The method according to claim 4, wherein reporting the keystrokes to the SCP comprises generating mid-call events at the switch in response to the keystrokes, and conveying the mid-call events over the telephone network to the SCP.

6. The method according to claim 4, wherein receiving the request comprises, responsively to the specified telephone number, reporting the request to the SCP, and wherein initiating the voice call and disconnecting the second leg comprise controlling functions of the switch responsively to instructions from the SCP.

7. The method according to claim 4, and comprising conveying data from the SCP to a server indicative of the keystrokes made by the user, and tabulating the data at the server.

8. The method according to claim 1, wherein receiving the request comprises presenting the user with a prompt on a medium unconnected with the telephone, the prompt soliciting a reply from the user by means of a telephone call to the specified telephone number, and wherein the signals are indicative of at least one keystroke made by the user in response to the prompt.

9. A method for collecting information from a user of a telephone having a keypad, the method comprising:
presenting the user with a prompt on a medium unconnected with the telephone, the prompt soliciting a reply from the user by means of a telephone call to a specified telephone number;
receiving a request at a switch in the telephone network to open a voice call from the telephone to the specified telephone number;
responsively to the request, opening a connection with the telephone over the telephone network; and
receiving signals over the connection responsively to one or more keystrokes made by the user on the keypad of the telephone, indicating the reply to the prompt presented on the medium.

10. The method according to claim 9, wherein opening the connection comprises opening a second leg of the connection from the switch to a peripheral device, and disconnecting the second leg after initiating the voice call, while leaving the first leg of the connection open for receiving the signals responsively to the one or more keystrokes.

11. The method according to claim 10, wherein the peripheral device comprises an audio response device, and wherein initiating the voice call comprises receiving an audio reply from the audio response device in response to opening the second leg of the connection.

12. The method according to claim 9, wherein the telephone network comprises a circuit-switched telephone network, operating in accordance with a Signaling System 7 (SS7) protocol.

13. The method according to claim 9, wherein receiving the signals comprises reporting the keystrokes to a service control point (SCP).

14. The method according to claim 13, wherein reporting the keystrokes to the SCP comprises generating mid-call events at the switch in response to the keystrokes, and conveying the mid-call events over the telephone network to the SCP.

15. The method according to claim 13, and comprising conveying data from the SCP to a server indicative of the keystrokes made by the user, and tabulating the data at the server.

16. The method according to claim 15, wherein tabulating the data comprises computing an output value based on the data, and comprising displaying the output value on the medium.

17. The method according to claim 16, wherein receiving the request comprises receiving multiple, respective requests from multiple users to open simultaneous voice calls to the specified telephone number, and wherein opening the connection comprises opening multiple simultaneous connections responsively to the requests, and wherein receiving the signals comprises receiving keystroke inputs from the multiple users over the simultaneous connections, and wherein computing the output value comprises tabulating selections made by the multiple users in response to the prompt, as indicated by the keystroke inputs.

18. The method according to claim 17, wherein the medium comprises a television medium, and wherein presenting the user with the prompt comprises providing the prompt in a television program, and wherein displaying the output value comprises presenting the output value on the television program following the prompt.

19. Apparatus for collecting information from a user of a telephone having a keypad, the apparatus comprising a service control point (SCP), which is adapted to receive a first message from a switch in a telephone network, indicative of a request received by the switch to open a voice call from the telephone to a specified telephone number, and responsively to the first message, to initiate a voice call by causing the switch to open a first leg of a connection from the switch to the telephone and to open a second leg of the connection from the switch to a peripheral device,
wherein the SCP is further adapted to instruct the switch to disconnect the second leg after initiating the voice call, while leaving the first leg of the connection open, and to receive a second message from the switch indicative of signals received at the switch over the first leg of the connection responsively to one or more keystrokes made by the user on the keypad of the telephone after disconnecting the second leg of the connection.

20. The apparatus according to claim 19, wherein the peripheral device comprises an audio response device, and wherein initiating the voice call causes the audio response device to issue an audio reply in response to opening the second leg of the connection.

21. The apparatus according to claim 19, wherein the telephone network comprises a circuit-switched telephone network, operating in accordance with a Signaling System 7-(SS7)-protocol.

22. The apparatus according to claim 19, wherein the second message comprises one or more mid-call events, which are conveyed by the switch over the telephone network in response to the one or more keystrokes.

23. The apparatus according to claim 19, wherein the SCP is adapted, responsively to the second message, to convey data to a server indicative of the keystrokes made by the user.

24. Apparatus for collecting information from a user of a telephone having a keypad, the apparatus comprising:
a medium unconnected with the telephone, which is controlled so as to present the user with a prompt soliciting a reply from the user by means of a telephone call to a specified telephone number;
a switch in the telephone network, which is adapted to receive a request to open a voice call from the telephone to the specified telephone number and to issue a first message over the telephone network responsively to the request; and
a service control point (SCP), which is coupled to the telephone network so as to receive the first message, and which is adapted, responsively to the first message, to cause the switch to open a connection with the telephone over the telephone network, so as to receive signals over the connection responsively to one or more keystrokes made by the user on the keypad of the telephone, indicating the reply to the prompt presented on the medium.

25. The apparatus according to claim 24, wherein the SCP is adapted to cause the switch to open a second leg of the connection from the switch to a peripheral device, and to disconnect the second leg after initiating the voice call, while leaving the first leg of the connection open for receiving the signals responsively to the one or more keystrokes.

26. The apparatus according to claim 25, wherein the peripheral device comprises an audio response device, which provides an audio reply in response to opening the second leg of the connection.

27. The apparatus according to claim 24, wherein the telephone network comprises a circuit-switched telephone network, operating in accordance with a Signaling System 7 (SS7) protocol.

28. The apparatus according to claim 24, wherein the SCP is adapted to instruct the switch to report the keystrokes to the SCP.

29. The apparatus according to claim 28, wherein the switch is adapted to report the keystrokes by generating mid-call events in response to the keystrokes, and conveying the mid-call events over the telephone network to the SCP.

30. The apparatus according to claim 28, and comprising a server, wherein the SCP is coupled to convey data to the server indicative of the keystrokes reported by the switch, and the server is adapted to tabulate the data.

31. The apparatus according to claim 30, wherein the server is adapted to compute an output value based on the data for display on the medium.

32. The apparatus according to claim 31, wherein the switch is adapted to receive multiple, respective requests from multiple users to open simultaneous voice calls to the specified telephone number, to open multiple simultaneous connections responsively to the requests, and wherein the switch is further adapted to receive keystroke inputs from the multiple users over the simultaneous connections, and wherein the server is adapted to tabulate selections made by the multiple users in response to the prompt, as indicated by the keystroke inputs.

33. The apparatus according to claim 32, wherein the medium comprises a television medium, and wherein the user is provided with the prompt in a television program, and wherein the output value is displayed on the television program following the prompt.
